(19) United States
(12) Patent Application Publication
(10) Pub. No.: US 2014/0163951 A1
(43) Pub. Date: Jun. 12, 2014

(54) HYBRID ADAPTATION OF NAMED ENTITY RECOGNITION

(71) Applicant: XEROX CORPORATION, Norwalk, CT (US)

(72) Inventors: Vassilina Nikoulina, Grenoble (FR); Agnes Sandor, Meylan (FR)

(73) Assignee: XEROX CORPORATION, Norwalk, CT (US)

(21) Appl. No.: 13/707,745

(22) Filed: Dec. 7, 2012

(51) Int. Cl. G06F 17/28

(52) U.S. Cl. CPC G06F 17/289
USPC 704/4; 704/2

(57) ABSTRACT

A machine translation method includes receiving a source text string and identifying any named entities. The identified named entities may be processed to exclude common nouns and function words. Features are extracted from the source text string relating to the identified named entities. Based on the extracted features, a protocol is selected for translating the source text string. A first translation protocol includes forming a reduced source string from the source text string in which the named entity is replaced by a placeholder, translating the reduced source string by machine translation to generate a translated reduced target string, while processing the named entity separately to be incorporated into the translated reduced target string. A second translation protocol includes translating the source text string by machine translation, without replacing the named entity with the placeholder. The target text string produced by the selected protocol is output.

### BACKGROUND

The exemplary embodiment relates to machine translation and finds particular application in connection with a system and method for named entity recognition.

A named entity is the name of a unique entity, such as a person or organization name, date, place, or thing. Identifying named entities in text is useful for translation of text from one language to another since it helps to ensure that the named entity is translated correctly.

Phrase-based statistical machine translation systems operate by scoring translations of a source string, which are generated by covering the source string with various combinations of biphrases, and selecting the translation (target string) which provides the highest score as the output translation. The biphrases, which are source language-target language phrase pairs, are extracted from training data which includes a parallel corpus of bi-sentences in the source and target languages. The biphrases are stored in a biphrase table, together with corresponding statistics, such as their frequency of occurrence in the training data. The statistics of the biphrases selected for a candidate translation are used to compute features for a translation scoring model, which scores the candidate translation. The translation scoring model is trained, at least in part, on a development set of source-target sentences, which allows feature weights for a set of features of the translation scoring model to be optimized.

The correct treatment of named entities is not an easy task for statistical machine translation (SMT) systems. There are several reasons for this. One source of error is that named entities create a lot of sparsity in the training and test data. While some named entities have acquired common usage and thus are likely to appear in the training data, others are used infrequently, or may have become known after the translation system has been developed, which is a particular problem in the case of news articles. Another problem is that named entities of the same type can often occur in the same context and yet are not treated in a similar way, in part because a phrase-based SMT model has very limited capacity to learn contextual information from the training data. Further, named entities can be ambiguous (e.g., Bush in George Bush vs. blackcurrant bush), and the wrong named entity translation can seriously impact the final quality of the translation.

There have been several proposals for integrating named entities into SMT frameworks. See, for example, Marco Turchi, et al., “ONTS: “Optima” news translation system,” Proc. of the Demonstrations at the 13th Conf. of the European Chapter of the Association for Computational Linguistics, April, 2012; Fei Huang, “Multilingual Named Entity extraction and translation from text and speech,” Ph.D. thesis, Language Technology Institute, School of Computer Science, Carnegie Mellon University, 2005. Most of these approaches apply an external resource for translating the named entities detected in the source sentence, in order to guarantee their correct translation. Such external resources can be either dictionaries of previously-mined multilingual named entities, as in Turchi 2012, transliteration processes (see Ulf Hermjakob, et al., “Name translation in statistical machine translation: learning when to transliterate,” Proc. ACL-08:HLT, pp. 389-397, 2008), or specific translation models for different types of named entities (see, Maoxi Li, et al., “The CASIA statistical machine translation system for IWSLT 2009,” Proc. IWSLT, pp. 83-90, 2009).

The named entity translation suggested by an external resource (NE translator) can be used as a default translation for the segment detected as a Named Entity, as described in Li 2009, or be added dynamically to the phrase-based table to compete with other phrases, as described in Turchi 2012 and Hermjakob 2008 (thus allowing more flexibility to the model), or be replaced by a fake (non-translatable) value to be re-inserted, which is replaced by the initial named entity once the translation is done, as described in John Tinsley, et al., “PLUTO: automated solutions for patent translation,” Proc. Workshop on ESIRMT and HyTra, pp. 69-71, April 2012.

Improvement due to named entity integration has been reported in few cases, mostly for “difficult” language pairs with different scripts and little training data, such as for Bangla-English (see, Santanu Pal, “Handling named entities and compound verbs in phrase-based statistical machine translation,” Proc. MWE 2010, pp. 46-54) and Hindi-English (see, Huang 2005). However, in the case of simpler language pairs with sufficient parallel data available, named entity integration has been found to bring very little or no improvement. For example, a gain of 0.3 on the BLEU score for French-English is reported in Dhouba Bouamour, et al., “Identifying multi-word expressions in statistical machine translation,” LREC 2012, Seventh International Conference on Language Resources and Evaluation, pp. 674-679, May 2012. A 0.2 BLEU gain is reported for Arabic-English in Hermjakob 2008, and a 1 BLEU loss for Chinese-English is reported in Agrawal 2010.

There are two main sources of error in SMT systems which attempt to cope with named entities: the way the named entities are integrated into the SMT system, and the errors of named entity recognition itself. Some have attempted a flexible named entity integration into SMT, where the SMT model may choose or ignore the translation suggested by an external NE translator (e.g., Turchi 2012, Hermjakob 2008). However, the second problem, namely errors due to named entity recognition itself in the context of SMT, has not been addressed. Moreover, since most of the named entity recognition systems are tailored for information extraction as the primary application, the requirements for named entity structure integrated within SMT may be different.

### INCORPORATION BY REFERENCE

The following references, the disclosures of which are incorporated herein by reference in their entireties, are mentioned:

Named entity recognition methods are described, for example, in U.S. application Ser. No. 13/475,250, filed May 18, 2012, entitled SYSTEM AND METHOD FOR RESOLVING ENTITY COREFERENCE, by Matthias Galle, et al.; U.S. Pat. Nos. 6,263,335, 6,311,152, 6,975,766, and 7,171,350, and U.S. Pub. Nos. 20080319978, 20090204596, and 20100082331.

U.S. Pat. No. 7,058,567, issued Jun. 6, 2006, entitled NATURAL LANGUAGE PARSER, by Aït-Mokhtar, et al., discloses a parser for syntactically analyzing an input string. The parser applies a plurality of rules which describe syntactic properties of the language of the input string.

Statistical machine translation systems are described, for example, in U.S. application Ser. No. 13/479,648, filed May 24, 2012, entitled DOMAIN ADAPTATION FOR QUERY TRANSLATION, by Vassilina Nikoulina, et al., U.S. application Ser. No. 13/596,470, filed on Aug. 28, 2012, entitled LEXICAL AND PHRASAL FEATURE DOMAIN ADAPTATION IN STATISTICAL MACHINE TRANSLATION, by Vassilina Nikoulina, et al.; U.S. application Ser. No. 13/173,582, filed Jun. 30, 2011, entitled TRANSLATION SYSTEM ADAPTED FOR QUERY TRANSLATION VIA A RERANKING FRAMEWORK, by Vassilina Nikoulina, et al., U.S. Pat. No. 6,182,026, and U.S. Pub. Nos. 20040024581, 20040030551, 20060190241, 20070150257, 20070265825, 20080300857, and 20100070521.

### BRIEF DESCRIPTION

In accordance with one aspect of the exemplary embodiment, a machine translation method includes receiving a source text string in a source language and identifying named entities in the source text string. Optionally, the method includes processing the identified named entities to exclude at least one of common nouns and function words from the named entities. Features are extracted from the optionally processed source text string relating to the identified named entities. For at least one of the named entities, based on the extracted features, a protocol is selected for translating the source text string. The protocol is selected from a plurality of translation protocols including a first translation protocol and a second translation protocol. The first protocol includes forming a reduced source string from the source text string in which the named entity is replaced by a placeholder, translating the reduced source string by machine translation to generated a translated reduced target string, processing the named entity separately, and incorporating the processed named entity into the translated reduced target string to produce a target text string in the target language. The second translation protocol includes translating the source text string by machine translation, without replacing the named entity with the placeholder, to produce a target text string in the target language. The target text string produced by the selected protocol is output.

A processor may implement one or more of the steps of the method.

In accordance with another aspect of the exemplary embodiment, a machine translation system includes a named entity recognition component for identifying named entities in an input source text string in a source language. Optionally, a rule applying component applies rules for processing the identified named entities to exclude at least one of common nouns and function words from the named entities. A feature extraction component extracts features from the optionally processed source text string relating to the identified named entities. A prediction component selects a translation protocol for translating the source string based on the extracted features. The translation protocol is selected from a set of translation protocols including a first translation protocol in which the named entity is replaced by a placeholder to form a reduced source string, the reduced source string is translated separately from the named entity, and a second translation protocol in which the source text string is translated without replacing the named entity with the placeholder, to produce a target text string in the target language. A machine translation component performs the selected translation protocol. A processor may be provided for implementing at least one of the components.

In accordance with another aspect of the exemplary embodiment, a method for forming a machine translation system includes optionally, providing rules for processing named entities identified in a source text string to exclude at least one of common nouns and function words from the named entities and, with a processor, learning a prediction model for predicting a suitable translation protocol from a set of translation protocols for translating the optionally processed source text string. The learning includes, for each of a training set of optionally processed source text strings: extracting features from the optionally processed source text strings relating to the identified named entities, and for each of the translation protocols, computing a translation score for a target text string generated by the translation protocol. The prediction model is learned based on the extracted features and translation scores. A prediction component is provided for applying the model to features extracted from the optionally processed source text string to select one of the translation protocols.

### BRIEF DESCRIPTION OF THE DRAWINGS

FIG. 1 is a flow diagram of a machine translation training and translation method in accordance with one aspect of the exemplary embodiment;

FIG. 2 is a functional block diagram illustrating a development system for adapting a named entity recognition component for development of a statistical machine translation system in accordance with another aspect of the exemplary embodiment;

FIG. 3 is a functional block diagram of a machine translation system which employs the adapted named-entity recognition component in accordance with another aspect of the exemplary embodiment;

FIG. 4 illustrates development of named entity processing rules in step S102 of the method of FIG. 1;

FIG. 5 illustrates development of a predictive model (classifier) in step S106 of the method of FIG. 1; and

FIG. 6 illustrates processing of an example sentence during learning of the prediction model.

### DETAILED DESCRIPTION

The exemplary embodiment provides a hybrid adaptation approach to named entity (NE) extraction systems, which fits better into an SMT framework than existing named entity recognition methods. The exemplary approach is used in statistical machine translation for translating text strings, such as sentences, form a source natural language, such as English or French, to a target natural language, different from the source language. As an example, the exemplary system and method have been shown to provide substantial improvements (2-3 BLEU points) for English-French translation tasks.

As noted above, existing named entity integration systems have not shown significant benefits. Possible reasons for this include the following:

errors by the named entity recognizer;
some named entities being a mixture of translatable and non-translatable elements (often the external named entity translation includes “transliterate-me” or “do not translate” modules, however, this cannot be applied blindly to any named entity; and
the integration of named entities being performed by constraining a phrase-based model to the unique translation of named entities (as suggested by an external named entity translator), however this may prevent the phrase-based model from using the phrases containing the same named entity in a larger context (and as a consequence, producing a better translation).

The exemplary system and method employ a hybrid approach which combines the strengths of rule-based and empirical approaches. The rules, which can be created automatically or by experts, can readily capture general aspects of language structure, while empirical methods allow a fast adaptation to new domains.

In the exemplary embodiment, a two-step hybrid named entity recognition (NER) process is employed. First, a set of post-processing rules is applied to the output of an NER component. Second, a prediction model is applied to the NER output in order to choose only those named entities for a special treatment that can actually be helpful for SMT purposes. The prediction model is one which is trained to optimize the final translation evaluation score.

A text document, as used herein, generally comprises one or more text strings, in a natural language having a grammar, such as English or French. In the exemplary embodiment, the text documents are all in the same natural language. A text string may be as short as a word or phrase but may comprise one or more sentences. Text documents may comprise images, in addition to text.

A named entity (NE) is a group of one or more words that identifies an entity by name. For example, named entities may include persons (such as a person's given name or role), organizations (such as the name of a corporation, institution, association, government or private organization), places (locations) (such as a country, state, town, geographic region, a named building, or the like), artifacts (such as names of consumer products, such as cars), temporal expressions, such as specific dates, events (which may be past, present, or future events), and monetary expressions. Of particular interest herein are named entities which are person names, such as the name of a single person, and organization names. Instances of these named entities are text elements which refer to a named entity and are typically capitalized in use to distinguish the named entity from an ordinary noun.

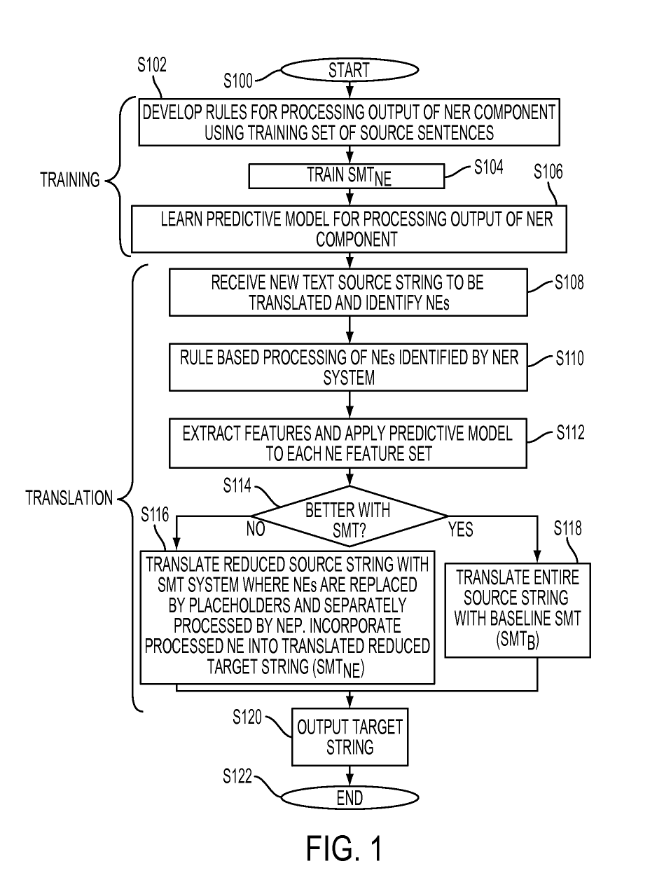

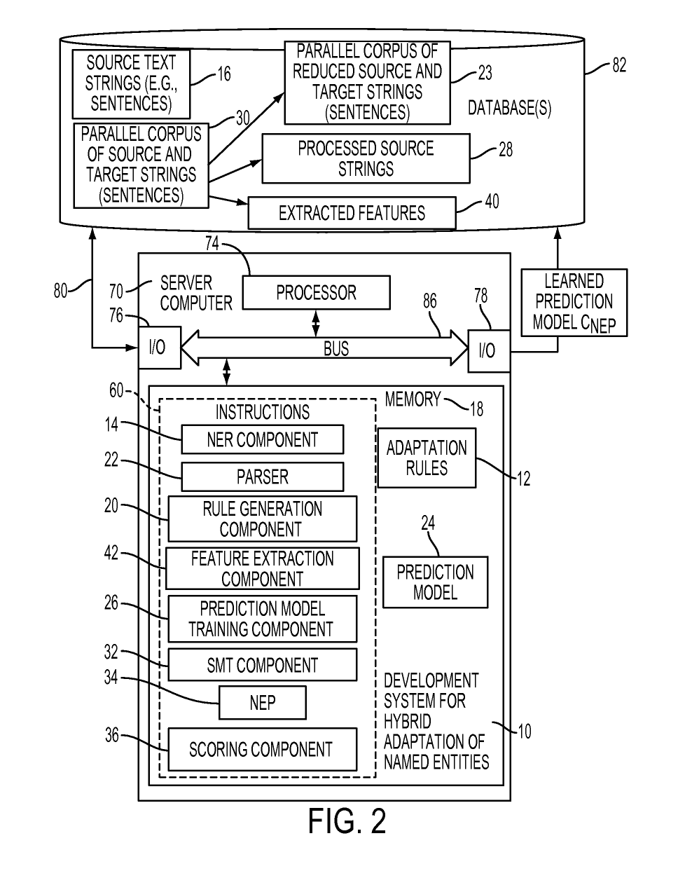

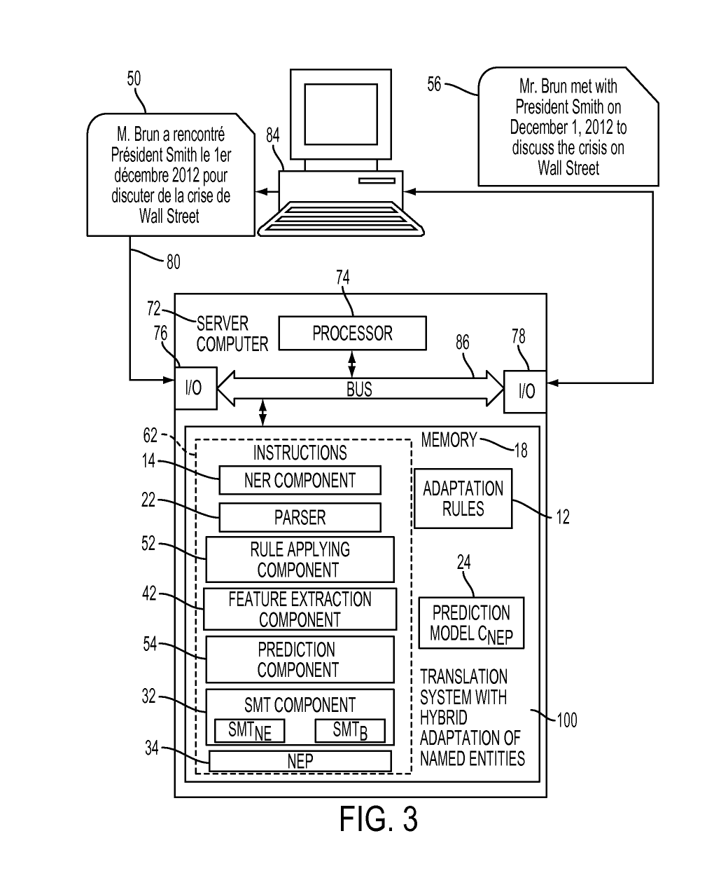

With reference to FIG. 1, an overview of an exemplary method for training and using a statistical machine translation system is shown. The training part can be performed with a machine translation development system 10 as illustrated in FIG. 2. The translation part can be performed with a machine translation system 100 as illustrated in FIG. 3. The method begins at S100.

At S102, adaptation rules 12 are developed for adapting the output of a named entity recognition (NER) component 14 to the task of statistical machine translation. This step may be performed manually or automatically using a corpus 16 of source sentences and the rules 12 generated stored in memory 18 of the system 10 or integrated into the rules of the NER component itself. FIG. 2, for example, shows a rule generation component 20 which receives named entities identified in the source text strings 12 and generates rules for excluding certain types of elements from the extracted elements that are considered to be better left for the SMT component 32 to translate. However, these rules may be generated partially or wholly manually. For example, a natural language parser 22, which may include the NER component 14, processes the source text and assigns parts of speech to the words (tokens) in the text. As part of this processing, common nouns and function words are labeled by the parser 22, allowing those which are within the identified named entities to be labeled.

At S104, an SMT model SMT_{NE} adapted for translation of source strings containing placeholders is learned using a parallel training corpus 23 of bi-sentences in which at least some of the named entities are replaced with placeholders selected from a predetermined set of placeholder types. In some embodiments, the adapted SMT_{NE} machine translation model may be a hybrid SMT model which is adapted to handle both placeholders and unreplaced named entities.

At S106, a prediction model 24 is learned by the system 10, e.g., by a prediction model learning component 26, using any suitable machine learning algorithm, such as support vector machines (SVM), linear regression, Naïve Bayes, or the like. The prediction model 24 is learned using a corpus 28 of processed source-target sentences. The processed source-target sentences 28 are generated from an initial corpus of source and target sentence pairs 30 by processing the source sentence in each pair with the NER component 14, as adapted by the adaptation rules 12, to produce a processed source sentence in which the named entities are labeled, e.g., according to type. The prediction model 24, when applied to a new source sentence, then predicts whether each identified named entity in the processed source sentence, as adapted by the adaptation rules, should be translated directly or be replaced by a placeholder for purposes of SMT translation and the NE subject to separate processing with a named entity processing (NEP) component 34. The prediction model training component 26 uses a scoring component 36 which scores translations of source sentences, with and without placeholder replacement, by comparing the translations with the target string of the respective source-target sentence pair from corpus 28. The scores, and features 40 for each of the named entities extracted from the source sentences by a feature extraction component 42, are used by the prediction model training component 26 to learn a prediction model 24 which is able to predict, given a new source string, when to apply standard SMT to an NE and when to use a placeholder and apply the NE translation model NEP 34. The corpus used for training the prediction model can be corpus 30 or a different corpus.

This completes the development (training) of a machine translation system. FIG. 3 illustrates such a machine translation system 100, which can be similarly configured to the system 10, except as noted, and where similar components are accorded the same numerals.

With continued reference to FIG. 1, and reference also to FIG. 3, at S108, a new text string 50 to be translated is received by the system 100. The source string is processed, including identification of any named entities.

At S110, any named entities identified by the NER component 14 are automatically processed with the adaptation rules 12, e.g., by a rule applying component 52, which may have been incorporated into the NER component 14 during the development stage. As in the development stage, a parser 22 can be applied to the input text to label the words with parts of speech, allowing common nouns and function words within the named entities to be recognized and some or all of them excluded, by the rule applying component 52, from those words that have been labeled as being part of a named entity by the named entity component 14.

At S112, the output source sentence, as processed by the NER component 14 and adaptation rules 12, is processed by a prediction component 54 which applies the learned prediction model 24 to identify those of the named entities which should undergo standard processing with the SMT component 32 and those which should be replaced with placeholders during SMT processing of the sentence, with the named entity being separately processed by the NEP 34. In particular, the feature extraction component 42 extracts features 40 from the source sentence, which are input to the prediction model 24 by the prediction model applying component 54. A translation protocol is selected, based on the prediction model's prediction. In one protocol, the named entity is replaced with a placeholder and separately translated while in another translation protocol, there is no replacement.

At S114, if the prediction model 24, predicts that the NEP component 34 will yield a better translation then at S116, the first translation protocol is applied: the named entity is replaced with a placeholder and separately processed with the NEP component 34, while the SMT component 32 is applied to the reduced source sentence (placeholder-containing string) to produce a translated, reduced target string containing one or more placeholders. After statistical machine translation has been performed (using the adapted SMT_{NE}), each of the placeholders is replaced with the respective NEP-processed named entity.

If, however, at S114 the prediction model 24 predicts that baseline SMT will yield a better translation, at S118 a second translation protocol is used. This may include applying a baseline translation model SMT_{B} of SMT component 32 to the entire sentence 50. Alternatively, a hybrid translation model SMT_{NE} is applied which is adapted to handling both placeholders and named entities. As will be appreciated, in a source string that contains more than one NE, each NE is separately addressed by the predictive model 24 and each is classified as suited to baseline translation or placeholder replacement with NEP processing. Those NEs suited to separate translation are replaced with a placeholder with the remaining NEs in the input string left unchanged. The entire string can then be translated with the hybrid SMT_{NE} model. Additionally, while two translation protocols are exemplified, there may be more than two, for example, where there is more than one type of NEP component.

At S120, a target string 56 generated by S116 and/or S118 is output.

The method ends at S122.

With reference to FIGS. 2 and 3, the exemplary systems 10, 100, each include memory 18 which stores instructions 60, 62 for performing the exemplary development or translation parts of the illustrated method. As will be appreciated, systems 10 and 100 could be combined into a single system. In other embodiments, the adaptation rules 12 and/or prediction model 22 learned by system 10 may be incorporated into an existing machine translation system to form the system 100.

Each system 10, 100 may be hosted by one or more computing devices 70, 72 and include a processor, 74 in communication with the memory 18 for executing the instructions 60, 62. One or more input/output (I/O) devices 76, 78 allow the system to communicate, via wired or wireless link(s) 80 with external devices, such as the illustrated database 82 (FIG. 2), which stores the training data 16, 30, 28 in the case of system 10, or with a client device 84 (FIG. 3), which outputs the source strings 50 to be translated and/or receives the target strings 56 resulting from the translation. Hardware components 18, 74, 76, 78 of the respective systems may communicate via a data/control bus 86.

Each computer 70, 72, 84 may be a PC, such as a desktop, a laptop, palmtop computer, portable digital assistant (PDA), server computer, cellular telephone, tablet computer, pager, combination thereof, or other computing device capable of executing instructions for performing all or part of the exemplary method.

The memory 18 may represent any type of non-transitory computer readable medium such as random access memory (RAM), read only memory (ROM), magnetic disk or tape, optical disk, flash memory, or holographic memory. In one embodiment, the memory 18 comprises a combination of random access memory and read only memory. In some embodiments, the processor 74 and memory 18 may be combined in a single chip. The network interface 76,78 allows the computer to communicate with other devices via a computer network, such as a local area network (LAN) or wide area network (WAN), or the internet, and may comprise a modulator/demodulator (MODEM) a router, a cable, and/or Ethernet port. Links 80 may form part of a wider network. Memory 18 stores instructions for performing the exemplary method as well as the processed data.

The digital processor 74 can be variously embodied, such as by a single-core processor, a dual-core processor (or more generally by a multiple-core processor), a digital processor and cooperating math coprocessor, a digital controller, or the like. The digital processor 74, in addition to controlling the operation of the computer 70, 72, executes instructions stored in memory 18 for performing the method outlined in FIGS. 1, 4 and 5.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIGS. 2 and 3 are each a high level functional block diagram of only a portion of the components which are incorporated into a computer system 70, 72. Since the configuration and operation of programmable computers are well known, they will not be described further.

Further details of the exemplary embodiments will now be described.

### Rule-Based Adaptation of NER System (S102)

The exemplary system 10, 100 can employ an existing NER system as the NER component 14. High-quality NER systems are available and are ready to use, which avoids the need to develop an NER component from scratch. However, existing NER systems are usually developed for the purposes of information extraction, where the NEs are inserted in a task-motivated template. This template determines the scope and form of NEs. In the case of SMT, the “templates” into which the NEs are inserted are sentences. For this purpose the NEs are best defined according to linguistic criteria, as this is a way to assure consistency of a language model acquired from sentences containing placeholders. This helps to avoid the placeholders introducing a sparsity factor into the language model similarly to the NEs. The following considerations are useful in designing rules for defining the scope and the form of the NEs for SMT:

1. The extracted NEs need not contain common nouns. Common nouns name general items. These are generally nouns that can be preceded by the definite article and that represent one or all of the members of a class. Common nouns are often relevant in an IE system, so existing NER systems often include them as part of the NE. However, many of these do not need special treatment for translation. Examples of such common nouns include titles of persons (such as Mr., Vice-President, Doctor, Esq., and the like) and various other common names (street, road, number, and the like). The rules 12 can be constructed so that these elements are removed from the scope of the NEs for SMT. In consequence these elements are translated as parts of the reduced sentence, and not in the NE translation system. In order to remove common nouns, the development system 10 and SMT system 100 includes a parser 22 which provides natural language processing of the source text string, either before or after the identification of NEs by the NER component 14.

2. The NEs are embedded in various syntactic structures in the sentences, and often the units labeled as named entities contain structural elements in order to yield semantically meaningful units for IE. These structural elements are useful for training the language model, and thus they are identified by the rules 12 so that they are not part of the NE. As an example, le 1er janvier can be stored as DATE(1er janvier) rather than DATE(le 1er janvier).

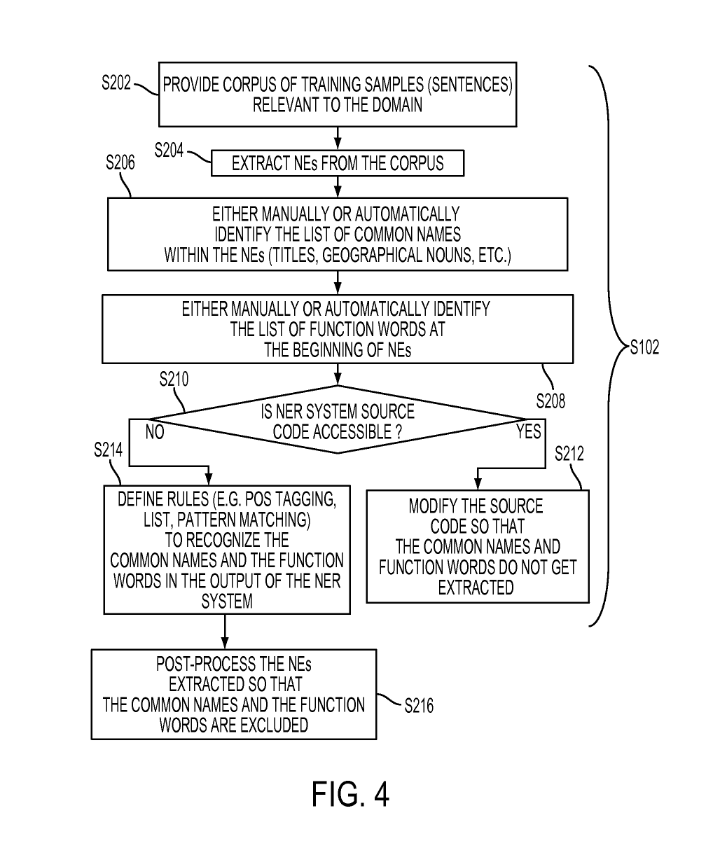

The rule-based part of the adaptation can proceed as shown in FIG. 4. Given an existing NER component 14, the adaptation (S102) can be executed as follows:

At S202 a corpus of training samples 16 is provided. These may be sentences in the source language (or shorter or longer text strings). The sentences may be selected from a domain of interest. For example, the sentences may be drawn from news articles, parliamentary reports, scientific literature, technical manuals, medical texts, or any other domain of interest from which sentences 50 to be translated are expected to come. Or, the sentences 16 can be drawn from a more general corpus if the expected use of the system 100 is more general.

At S204, the sentences 16 are processed with the NER component 14 to extract NEs. This may include parsing each sentence with the parser 22 to generate a sequence of tokens, assigning morphological information to the words, such as identifying nouns and noun phrases and tagging some of these as named entities, e.g., by using a named entity dictionary, online resource, or the like. Each named entity may be associated with a respective type selected from a predetermined set of named entity types, such as PERSON, DATE, ORGANIZATION, PLACE, and the like.

At S206, from the NEs extracted from the corpus 16, a list of common names which occur within the extracted NEs is identified, which may include titles, geographical nouns, etc. This step may be performed either manually or automatically, by the system 10. In some embodiments, the rule generation component 20 may propose a list of candidate common names for a human reviewer to validate. In the case of manual selection, at S206, the rule generation component 20 receives the list of named entities with common names that have been manually selected.

At S208, a list of function words at the beginning of the extracted NEs is identified, either manually or automatically.

If at S210 the NER system is a black box (i.e., the source code is not accessible, or it is desirable to leave the NER component intact for other purposes, define rules (e.g. POS tagging, list, pattern matching) to recognize the common names and the function words in the output of the NER system.

The rule generation component generates appropriate generalized rules for excluding each of the identified common names from named entities output by the NER component. Specific rules may be generated for cases where the function word or common name should not be excluded, for example, where the common noun follows a person name, as in George Bush. The common names to be excluded may also be limited to a specific set or type of common names. Additionally, different rules may be applied depending on the type of named entity, such as different rules for PERSON and LOCATION.

For example, rules may specify: “if a named entity of type PERSON begins with M., Mme., Dr., etc. (in French), then remove the respective title (common name)”, or “if a named entity of type LOCATION includes South of LOCATION, North LOCATION (in English), or Sud de la LOCATION, or LOCATION Nord (in French), then remove the respective geographical name (common name)”.

In the case of function words, for example, rules may specify “if a named entity is of the type DATE and begins with le (in French), then remove le from the words forming the named entity string.” The NEs extracted are post-processed so that the common names and the function words are deleted.

At S210, if the source code of the NER component 14 is available, then at S212, the source code may be modified so that the common names and function words do not get extracted as part of an NE, i.e., the NER component applies the rules 12 as part of the identification of NEs. Otherwise, at S214 a set of rules 12 is defined and stored (e.g., based on one or more of POS tagging, a list, and pattern matching) to recognize the common names and the function words in the output of the NER system and exclude them from the NEs.

At S216, the source strings in the bilingual corpus 30 are processed with the NER component 14 and rules 12 prior to the machine learning stage. The target sentence in each source-target sentence pair remains unmodified and is used to score translations during the prediction model learning phase. As will be appreciated, in some embodiments, the source strings 16 can simply be the source strings from the bilingual corpus 30.

### Training the SMT_{NE} Machine Translation Component (S104)

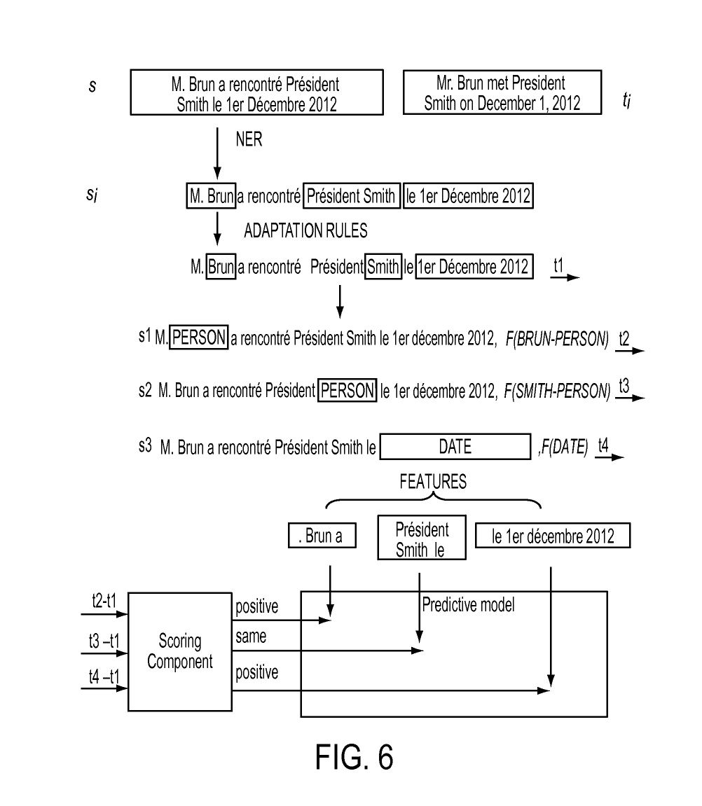

The translation of the reduced sentence (sentence containing one or more placeholders) can be performed with an SMT model (SMT_{NE}) of SMT component 32 which has been trained on similar sentences. The training of the reduced translation model SMT_{NE} can thus be performed with a parallel training corpus 23 (FIG. 2) containing sentence pairs which are considered to be translations of each other, in at least the source to target direction and which include placeholders, i.e., a corpus of source sentences and corresponding target sentences in which both source and target Named Entities are replaced with their placeholders (after processing the source side with NER adaptation rules). In order to keep consistency between source and target Named Entities, the source Named Entities can be projected to the target part of the corpus using a statistical word-alignment model (similar to that used by Fei Huang and Stephan Vogel, “Improved named entity translation and bilingual named entity extraction,” Proceedings of the 4th IEEE International Conference on Multimodal Interfaces, ICMI '02, pages 253-260, Washington, D.C., USA. IEEE Computer Society. 2002). Thus, for example, in the source sentence shown in FIG. 6, a statistical alignment technique can be used to predict which word or words in the translation that is aligned with the word Brun. In this case, it is very likely that the alignment component would output the word Brun, however, this may not always be the case.

To produce a hybrid translation model, a Named Entity and its projection (likely translation) are replaced with a placeholder defined by the NE type with probability a. The hybrid reduced model is able to deal both with the patterns containing a placeholder and with the real Named Entities. This provides a translation model that is able to deal with Named Entity placeholders and which is also capable of dealing with the original Named Entity as well, to allow for the cases where the predictive model 24 chooses not to replace it. Thus, a hybrid model is trained, by replacing only a fraction of Named Entities detected in the training data with the placeholder. Parameter a defines this fraction, i.e., parameter a controls the frequency with which a Named Entity is replaced with a placeholder. A value of 0<α<1 is selected, such as from 0.3-0.7. In the exemplary embodiment, α is 0.5, i.e., for half of the named entity occurrences (e.g., selected randomly or alternately throughout the training set), the Named Entity is retained and for the remaining half of the occurrences, placeholders are used for that named entity on the source and target sides. The aim is that the frequent NEs will still be present in the training data in their original form, and translation model will be able to translate them. However, the 50% of NEs that are replaced with placeholders allow the system to make use of more general patterns (e.g., le +NE_DATE=on +NE_DATE) that can be applied to new Named Entity translations.

As will be appreciated, the SMT_{NE} hybrid translation system thus developed can be used for translation of source strings in which there are no placeholders, i.e., the baseline SMT_{B} system is not needed.

The reduced parallel corpus can be created from corpus 30 or from a separate corpus. Using the reduced parallel corpus, statistics can be generated for biphrases in a phrase table in which some of the biphrases include placeholders on the source and target sides. These statistics may include translation probabilities, such as lexical and phrasal probabilities in one or both directions (source to target and target to source). Optionally a language model may be incorporated for computing the probability of sequences of words on the target side, some of which may include placeholders. The phrase based statistical machine translation component 32 then uses the statistics for the placeholder biphrases and modified language model in computing the optimal translation of a reduced source string. As normal, biphrases are drawn from the biphrase table to cover the source string to generate a candidate translation and a scoring function scores the translation based on features that use the statistics from the bi-phrase table and the language model and respective weights for each of the scoring features. See, for example, Koehn, P., Och, F. J., and Marcu, D., “Statistical Phrase-Based Translation,” Proc. 2003 Human Language Technology Conference of the North American Chapter of the Association for Computational Linguistics, Edmonton, Canada. (2003); Hoang, H. and Koehn, P., Design of the Moses Decoder for Statistical Machine Translation,” ACL Workshop on Software Engineering, Testing, and Quality Assurance for NLP (2008); and references mentioned above, for a fuller description of phrase based statistical machine translation systems which can be adapted for use herein.

The placeholders are representative of the type of NE which is replaced and are selected from a predetermined set of placeholders, such as from 2 to 20 different types. Examples of placeholder types include PERSON, ORGANIZATION, LOCATION, DATE, and combinations thereof. In some embodiments, more fine-grained NE types may be used as placeholders, such as LOCATION-COUNTRY, LOCATION-CITY, etc.

### Machine Learning of NER Adaptation (S106)

The NER post-processing rules developed in S102 are beneficial for helping the SMT component 32 to deal with better-formed Named Entities. The preprocessing leads to a segmentation of NEs which is more suitable for SMT purposes, and which separates clearly the non-translatable units composing an NE from its context. However, the benefits of using SMT on certain NEs or NE types may vary across different domains and text styles. It may also be dependent on the SMT model itself. For example, simple NEs that are frequent in the data on which the SMT component 32 was trained are already well-translated by a baseline SMT model, and do not require separate treatment, which could, in some hurt the quality of the translation.

The impact of the treatment of a specific Named Entity on a final translation quality may depend on several different factors. These may include the NE context, the NE frequency in the training data, the nature of the NE, the quality of the translation by the NEP (produced by an external NE adapted model), and so forth. It has been found that the impact of each of these factors may be very heterogeneous across the domains, and a rule-based approach is generally not suitable to address this issue.

In the exemplary embodiment, therefore, a prediction model 24 is learned, based on a set of features 40 that are expected to control these different aspects. The learned model is then able to predict the impact that the special NEP treatment of a specific NE may have on the final translation. The primary objective of the model 24 is thus to be able to choose only NEs that can improve the final translation for special treatment with the NEP, and reject the NEs that can hurt or make no difference for the final translation, allowing them to be processed by the conventional SMT component 32. In order to achieve this objective, an appropriate training set is provided as described at S216.

In what follows it is assumed that an SMT model 32 has been enriched with NER component 14, which will be referred to as SMT_{NE}: this system makes a call for an external translation model (NEP 34) to translate the Named Entities detected in the source sentence and these translations are then integrated into the final translation.

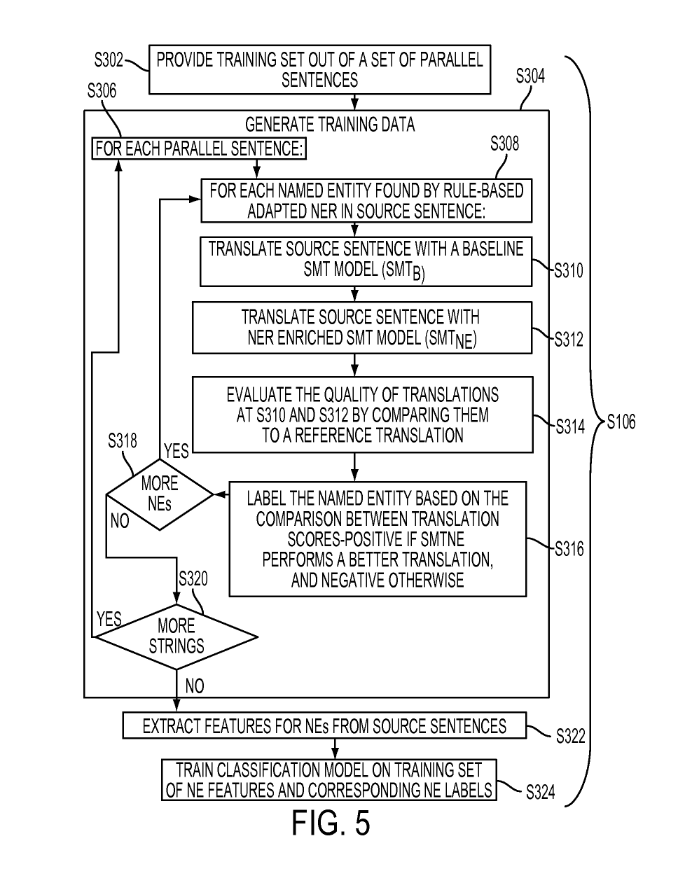

FIG. 5 illustrates the learning of the prediction model 24 (S106) which decides when to apply placeholder replacement of named entities and translation with an adapted SMT model SMT_{NE}.(S114).

At S302, a training set for learning the prediction model 24 is created out of a set of parallel sentences (sᵢ,tᵢ), i=1 . . . N. This can be the output of S216, from corpus 28. Each sᵢ is a source string and tᵢ is the corresponding, manually translated target string, which serves as the reference translation, and N can be at least 50, or at least 100 or at least 1000.

At S304, training data is generated, as follows:

1. For each sentence from the training set i=1 . . . N (S306):

2. For each Named Entity NE found by the rule-based adapted NER in sᵢ (S308):

3. Translate sᵢ with the baseline SMT model: SMT_{B}(sᵢ), where the named entity is translated as part of the sentence by the SMT component 32 (S310);

4. Translate sᵢ with the NER enriched SMT model: SMT_{NE}(sᵢ), where the named entity is replaced by a placeholder, is separately is translated by the NEP component 34, and then inserted into the reduced sentence which has been translated by the SMT component 32 (S310), which may have been specifically trained on placeholder containing bi-sentences;

5. Evaluate the quality of SMT_{B}(sᵢ) and SMT_{NE}(sᵢ) by comparing them to the reference translation tᵢ. A score is generated for each translation with the scoring component 36. The corresponding evaluation scores are referred to herein as scoreSMT_{B}(sᵢ) for the baseline SMT model where the NEP is not employed, and scoreSMT_{NE}(s) for the SMT model adapted by using the NEP (S312);

6. A label is applied to each NE. The label of the named entity NE is based on the comparison (difference) between scoreSMT_{NE}(sᵢ) and scoreSMT_{B}(sᵢ). For example the label is positive if SMT_{NE} performs a better translation than SMT_{B}, and negative if it is worse, with samples that score the same being given a same label (S312), i.e., a trifold labeling scheme although in other embodiments a binary labeling (e.g., equal or better vs. worse) or a scalar label could be applied which is a function of the difference between the two scores.

The method proceeds to S318, where if there are more NEs in string sᵢ, the method returns to S308, otherwise to S320. At S320, if there are more parallel sentences to be processed, the method returns to S306 to process the next parallel sentence pair, otherwise to S322.

At S322, features 40 are extracted from the source strings sᵢ. In particular, for each NE, a feature vector or other feature representation is generated which includes a feature value for each of a plurality of features in a predetermined set of features. As noted above, these may include the NE context, the NE frequency in the training data, the nature of the NE (PERSON, ORGANIZATION, LOCATION, DATE), and so forth.

At S324, a classification model 24 is trained on a training set generated from the NEs, i.e., on their score labels, and extracted features. The classification model is thus optimized to choose the NEs NE that improve the final translation quality for treatment with the NEP.

The method can be extended for the case when multiple NE translation systems 34 are available: e.g., do not translate/transliterate (e.g., for person names), rule-based (e.g., 15 EUR=600 RUB), dictionary based, etc. In this case, the translation prediction model 24 can be trained as a multi-class labeling model, where each class corresponds to the model that should be chosen for a particular NE translation model.

FIG. 6 illustrates the method of FIGS. 4 and 5 on an example parallel sentence pair. The source sentence s, in French, is first processed by the NER component 14, which labels M. Brun, Président Smith and le 1er décembre 2012 as NEs. The first two are labeled as named entities of type PERSON, and the last one of type DATE.

The adaptation rules 12 are applied, and yield sentence sᵢ where the named entities are simply Brun (PERSON), Smith (PERSON) and 1er décembre 2012 (DATE).

A first translation t₁ is generated with the baseline translation system 32 using the full source sentence. In some cases, this could result in a translation in which Brun is translated to Brown. When compared with the reference translation tᵢ, by the scoring component, this yields a score, such as a TER (translation edit rate) or BLEU score.

The system then selects the first NE, Brun and substitutes it with a placeholder which can be based on the type of named entity which has been identified, in this case PERSON, to generate a reduced source sentence s₁. The SMT component 32 (specifically, the SMT_{NE}, which has been trained for translating sentences with placeholders) translates this reduced sentence while the NEP component provides separate processing for the person name Brun. The result of the processing is substituted in the translated reduced sentence. In some cases, the NEP may leave the NE unchanged, i.e., Brun, while in other cases, the rules, patterns, or dictionary applied by the NEP component may result in a new word or words being inserted. Features are also extracted for each placeholder. As examples, the features can be any of those listed below. The example features are represented in FIG. 6 as F(Brun-PERSON), F(Smith-PERSON), and F(DATE), and can each be a feature vector 40.

Each resulting translation t₂, t₃, t₄ is compared with the reference translation tᵢ, by the scoring component. This yields a score, on the same scoring metric as for t₁, in this case, a Bleu score. The scores are associated with the respective features for inputting. Since the Bleu score is higher for “better” translations, if the score for t₂ is better than t₁, then the feature set F(Brun-PERSON) receives a positive (+) label and the following example is added to the training set:+(label):F(Brun-PERSON).

The scoring component outputs the labels for each feature vector to the prediction model training component 26 which learns a classifier model (prediction model 24), based on the labels and their respective features 40. On a training set obtained in this way a classifier C_{NEP}: F->{−1, 0, 1}, which maps a feature vector into a value from a {−1, 0, 1} set, with −1 representing a feature vector which is negative (better with the baseline system, SMT_{B}), 0 representing a feature vector which is neither better nor worse with the baseline system, and 1 representing a feature vector which is positive (better with the adapted system SMT_{NE}).

During the translation stage, given an input sentence 50 to be translated (S108), the prediction model applying component 54 extracts features for each adapted NE in the same way as during the learning of the model 24, which are input to the trained model 24. The model 24 then predicts whether the score will be better or worse when the NEP component 34 is used, based on the input features. If the score is the same as for the baseline SMT translation, the system has the option to go with the baseline SMT or use the NEP 34 for processing that NE. For example, the system 100 may apply a rule which retains the baseline SMT when the score is the same.

For example, given the French sentence s in FIG. 6, then for each potential NE compute F(NE), and obtain the classifier prediction for that feature set. As an example, let:

1. Brun-PERSON→F(Brun-PERSON)→C_{NEP}(F(Brun-PERSON))=1

2. Smith-PERSON→F(Smith-PERSON)→C_{NEP}(F(Smith-PERSON))=0

3. DATE→F(DATE)→C_{NEP}(F(DATE))=−1

Then, the following sentence is sent to SMT_{NE}: M. PERSON a rencontré Président Smith le 1er décembre 2012 as discussed for S116 of FIG. 1. The output at S120 is the translated string.

### Example Features

The features used to train the model 24 (S106) and for assigning a decision on whether to use the NEP 34 can include some or all of the following:

1. Named Entity frequency in the training data. This can be measured as the number of times the NE is observed in a source language corpus, such as corpus 16 or 30. The values can be normalized e.g., to a scale of 0-1.

2. Confidence in the translation of an NE dictionary used by the NEP

34. As will be appreciated, there can be more than one possible translation for a given NE. For example, if NE_{S} is the source named entity, and NEₜ is the translation suggested for NE_{S} by the NE dictionary, confidence is measured as p(NEₜ/NE_{S}), estimated on the training data used to create the NE dictionary.

3. feature collections defined by the context of the Named Entity: the number of features in this collection corresponds to the number of n-grams that occurs in the training data which include the NE. In the example embodiment, trigrams (three tokens) are considered. Each collection is thus of the following type: a named entity placeholder extended with its 1-word left and right context (e.g., from the string The meeting, which was held on the 5th of March, ended without agreement: the context: the +NE_DATE+, can be extracted, i.e., the context at each end can be a word or other token, such as a punctuation mark). Feature collections could also be bigrams, or other n-grams, where n is from 2-6, for example. Since these features may be sparse they could be represented by an index, for example, if the feature the +NE_DATE+, is found, its index, such as the number 254, could be used as a single feature value.

4. The probability of the Named Entity in the context (e.g., trigram) estimated from the source corpus (a 3-gram Language Model). This is the probability of finding a trigram in the source corpus that is the Named Entity with its preceding and subsequent tokens, (e.g., the probability of finding the sequence: the +5th of March +,). The source corpus can be the source sentences in corpus 30 or may be a different corpus of source sentences, e.g., sentences of the type which are to be translated.

5. The probability of the placeholder replacing a Named Entity in the context (3-gram reduced Language Model). This is the probability of finding a trigram in the source corpus that is the placeholder with its preceding and subsequent tokens (e.g., the probability of finding the sequence: the +NE_DATE +,).

The named entity recognition component 14 can be any available named entity recognition component for the source language. As an example, the named entity recognition component employed in the Xerox Incremental Parser (XIP), may be used, as described, for example, in U.S. Pat. No. 7,058,567 to Ait-Mokhtar, and US Pub. No. 20090204596 to Brun, et al., and Caroline Brun, et al., “Intertwining deep syntactic processing and named entity detection,” ESTAL 2004, Alicante, Spain, Oct. 20-22 (2004), the disclosures of which are incorporated herein by reference in their entireties.

As will be appreciated, the baseline SMT system of component 32 may use internal rules for processing named entities recognized by the NER component 14. For example, it may use simplified rules which do not translate capitalized words within a sentence.

The NE translation model 34 can be dependent on the nature of the Named Entity: it can keep the NE untranslated or may transliterate it (e.g., in the case of PERSON), it can be based on pre-defined hand-crafted, or automatically learned rules (e.g., UNITS, 12 mm=12 mm), it can be based on an external Named Entity dictionary (which can be extracted from Wikipedia or from other parallel texts), a combination thereof, or the like.

For further details on the BLEU scoring algorithm, see, Papineni, K., Roukos, S., Ward, T., and Zhu, W. J. (2002). “BLEU: a method for automatic evaluation of machine translation” in ACL-2002: 40th Annual meeting of the Association for Computational Linguistics pp. 311-318. Another objective function which may be used is the NIST score.

While the exemplary systems and method use both the NE adaptation and prediction learning (S102, S106) and processing (S110, S112), it is to be appreciated that these techniques may be used independently, for example, in a translation system which uses the predictive model but no NE adaptation, or which uses NE adaptation but no prediction.

The procedure of creating an annotated training set for learning the prediction model which optimizes the MT evaluation score as described above can be applied to tasks other than NER adaptation. More generally, it can be applied to any pre-processing step done before the translation (e.g., spell-checking, sentence simplification, and so forth). The value of applying a prediction model to these steps is to make the pre-process model more flexible and adapted to the SMT model to which it is applied.

The method illustrated in any one or more of FIGS. 1, 4 and 5 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method(s) may be implemented in transitory media, such as a transmittable carrier wave in which the control program is embodied as a data signal using transmission media, such as acoustic or light waves, such as those generated during radio wave and infrared data communications, and the like.

The exemplary method(s) may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in one or more of FIGS. 1, 4 and 5, can be used to implement the method exemplary method.

Without intending to limit the scope of the exemplary embodiment, the following example illustrates the application of the system and method.

### Example

To demonstrate the applicability of the exemplary system and method, experiments were performed on the following framework for Named Entity Integration into the SMT model.

1. Named Entities in the source sentence are detected and replaced with placeholders defined by the type of the NE (e.g., DATE, ORGANIZATION, LOCATION).

2. The initial source sentence with the NEs replaced and the original Named Entity that was replaced are translated independently.

3. The placeholder in the reduced translation is replaced by the corresponding NE translation.

An example below illustrates the translation procedure:

Source:

Proceedings of the Conference, Brussels, May 8, 1996 (with contributions of George, S.; Rahman, A.; Alders, H.; Platteau, J. P.)

First, SMT-adapted NER is applied to the source sentence to replace named entities with placeholders corresponding to respective named entity types:

Reduced Source:

Proceedings of the Conference, +NE_LOCORG_CITY, +NE_DATE (with contributions of +NE_PERSON, S.; Rahman A.; Alders, H.; Platteau, J. P.)

The reduced source sentence is translated with the reduced translation model:

Reduced Translation:

compte rendu de la conférence, +NE_LOCORG_CITY, +NE_DATE (avec les apports de +NE_PERSON, s.; rahman, A.; l'aulne, h.; platteau, j. p.)

The translation of the replaced NEs is performed with the special NE-adapted model (NE translation model 32);

NE Translation:
Brussels=Bruxelles,
May 8, 1996=8 mai 1996,
George=George.

The Named Entity translations are then re-inserted into the reduced translation. This is performed based on the alignment produced internally by the SMT system.

Final Translation:

Compte rendu de la conférence, Bruxelles, 8 mai 1996 (avec les apports de George, S.; Rahman, A.; l'aulne, H.; Platteau, J. P.)

In such a framework, a reduced translation model is first trained that is capable of dealing with the placeholders correctly. Second, the method is able define how the Named Entities will be translated.

The training of the reduced translation model is performed with a reduced parallel corpus (a corpus with both source and target Named Entities are replaced with their placeholders). In order to keep consistency between source and target Named Entities the source Named Entities are projected to the target part of the corpus using a statistical word-alignment model, as described above.

A Named Entity and its projection are then replaced with a placeholder defined by the NE type with probability α. This provides a hybrid reduced model, which is able to deal both with the patterns containing a placeholder and the real Named Entities (e.g., in the case where a sentence contains more than one NE and only one is replaced with a placeholder).

Next, a phrase-based statistical translation model is trained on the corpus obtained in this way, which allows the model to learn generalized patterns (e.g., on +NE_DATE=le +NE_DATE) for better NE treatment. The replaced Named Entity and its projection can be stored separately in the Named Entity dictionary that can be further re-used for NE translation.

Such an integration of NER into SMT addresses multiple problems of NE translation:

1. It helps phrase-based SMT to generalize training data containing Named Entities. The generalized patterns can be helpful for dealing with rare or non-seen Named Entities.

2. The generalization also allows the sparsity of the training data to be reduced, and, as a consequence, to allow a better model to be learned;

3. The model allows ambiguity to be reduced or eliminated when translating ambiguous NEs.

As a baseline NER component 14, the NER component of the XIP English and French grammars was used. XIP was run on a development corpus to extract lists of NEs: PERSON, ORGANIZATION, LOCATION, DATE. Using this list, a list of common names and function words was identified that should be eliminated from the NEs. In the XIP grammar, NEs are extracted by local grammar rules as groups of labels that are the POS categories of the terminal lexical nodes in the parse tree. The post-processing (S212) entailed re-writing the original groups of labels with ones that exclude the unnecessary common names and function words.

The prediction model 24 for SMT adaptation was based on the following prediction model features 40:

1. Named Entity frequency in the training data;

2. confidence in the translation of an NE dictionary; (confidence is measured as p(NEₜ/NEₛ), estimated on the training data used to create the NE dictionary);

3. feature collections defined by the context of the Named Entity: the number of features in this collection corresponds to the number of trigrams that occurs in the training data of the following type: a named entity placeholder extended with its 1-word left and right context.

4. the probability of the Named Entity in the context estimated from the source corpus (a 3-gram Language Model);

5. the probability of the placeholder replacing a Named Entity in the context (3-gram reduced Language Model);

The corpus used to train the prediction model 24 contained 2000 sentences (a mixture of titles and abstracts). A labeled training set was created out of a parallel corpus as described above. The TER (translation edit rate) score was used for measuring individual sentence scores. Overall, 461 labeled samples were obtained, with 172 positive examples, 183 negative examples, and 106 neutral examples (where SMT_{NE} and SMT_{B} lead to the same performance). A 3-class SVM prediction model was learned and only the NEs which are classified as a positive example are chosen to be replaced (processed by the NEP) at test time.

### Experiments

Experiments were performed on the English-French translation task in the agricultural domain. The in-domain data was extracted from bibliographical records on agricultural science and technology provided by the FAO and INRA. The corpus contains abstracts and titles in different languages. It was further extended with a subset of the JRC-Aquis corpus, based on the domain-related Eurovoc categories. Overall, the in-domain training data consisted of about 3 million tokens per language.

The NER adaptation technique was tested on two different types of test samples extracted from the in-domain data: 2000 titles (test-titles) and 500 abstracts (test-abstracts).

The translation performance of the following translation models was compared:

1. SMT_{B}: a baseline phrase-based statistical translation model, without Named Entity treatment integrated.

2. SMT_{NE} not adapted: SMT_{B} with NE integrated SMT_{NE} which relies on a non-adapted (baseline) NER system, i.e., named entities are recognized but are not processed by the rule applying component 52 or prediction model applying component 54.

3. ML-adapted SMT_{NE}: SMT_{NE} extended with the prediction model 24, i.e., named entities are recognized and processed with the prediction model applying component 54 but are not processed by the rule applying component 52.

4. RB-adapted SMT_{NE}: SMT_{NE} extended with the rule-based adaptation, i.e., named entities are recognized and processed by the rule applying component 52 but are not by the prediction model applying component 54.

5. full-adapted SMT_{NE}: SMT_{NE} relying both on rule-based and machine learning adaptations for NER, i.e., named entities are recognized and processed by the rule applying component 52 and the prediction model applying component 54.

The translation quality of each of the translation systems was evaluated with BLEU and TER evaluation measures, as shown in TABLE 1.

TABLE 1
Results for NER adaptation for SMT

| | |
|---|---|
| test-titles | test-abstracts |

| Model | BLEU | TER | BLEU | TER |
|---|---|---|---|---|
| SMT_{B} (baseline) | 0.3135 | 0.6566 | 0.1148 | 0.8935 |
| SMT_{NE} not adapted | 0.3213 | 0.6636 | 0.1211 | 0.9064 |
| ML-adapted SMT_{NE} | 0.3371 | 0.6523 | 0.1228 | 0.9050 |
| RB-adapted SMT_{NE} | 0.3258 | 0.6605 | 0.1257 | 0.8968 |
| Full-adapted SMT_{NE} | 0.3421 | 0.6443 | 0.1341 | 0.8935 |

Table 1 shows that both Machine Learning and Rule-based adaptation for NER lead to gains in terms of BLEU and TER scores over the baseline translation system. Significantly, it can be seen that the combination of the two steps gives even better performance, suggesting that both of these steps should be applied for NER adaptation for better translation quality.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A machine translation method comprising:
receiving a source text string in a source language;
identifying named entities in the source text string;
optionally, processing the identified named entities to exclude at least one of common nouns and function words from the named entities;
extracting features from the optionally processed source text string relating to the identified named entities;
with a processor, for at least one of the named entities, based on the extracted features, selecting a protocol for translating the source text string, the protocol being selected from a plurality of translation protocols,
a first of the translation protocols including:
forming a reduced source string from the source text string in which the named entity is replaced by a placeholder;
translating the reduced source string by machine translation to generated a translated reduced target string,
processing the named entity separately, and
incorporating the processed named entity into the translated reduced target string to produce a target text string in the target language;
a second of the translation protocols including:
translating the source text string by machine translation, without replacing the named entity with the placeholder, to produce a target text string in the target language; and
outputting the target text string produced by the selected protocol.

2. The method of claim 1, wherein the features include features selected from the group consisting of:
a frequency of the named entity in training data;
a confidence in the translation of a named entity dictionary used in the separate processing of the named entity;
a feature defined by a context of the named entity in the source string;
a probability of the named entity in the context, estimated on a source corpus;
a probability of the placeholder replacing the named entity in the context, estimated on a source corpus;
and combinations thereof.

3. The method of claim 1, wherein selecting of the translation protocol comprises, with a prediction model, predicting which of the translation protocols would yield a better translation.

4. The method of claim 3, further comprising training the predictive model on features extracted for named entities of a set of training source strings, and a comparison of a translation score for each source string in which the named entity is replaced by a placeholder and translated separately and a translation score for the respective source string without the replacement.

5. The method of claim 1, wherein the method includes the processing of the identified named entities to exclude at least one of common nouns and function words from the named entities.

6. The method of claim 5, wherein the processing of the identified named entities to exclude at least one of common nouns and function words from the named entities is performed with a set of predefined rules.

7. The method of claim 1, wherein the identifying of named entities in the source string comprises identifying a type of the named entity, the type of named entity being selected from a predefined set of named entity types and wherein the placeholder comprises the identified type of named entity.

8. The methods of claim 7, wherein the set of named entity types includes named entity types selected from the group consisting of PERSON, ORGANIZATION, LOCATION, and DATE.

9. The method of claim 7, wherein the translating of the reduced source string by machine translation to generated the translated reduced target string comprises translating the reduced source string with a machine translation model which has been trained on a parallel training corpus of source and target text strings in which at least some of the named entities are replaced by placeholders.

10. The method of claim 9, wherein some of the named entities in the parallel training corpus are not replaced by placeholders to produce a hybrid translation model which is adapted for translation of the source string in both protocols.

11. The method of claim 1, wherein the machine translation comprises phrase-based statistical machine translation.

12. A computer program product comprising a non-transitory medium storing instructions, which when executed by a computer, perform the method of claim 1.

13. A system comprising memory storing instructions for performing the method of claim 1 and a processor, in communication with the memory, for executing the instructions.

14. A machine translation system comprising:
a named entity recognition component for identifying named entities in an input source text string in a source language;
optionally, a rule applying component which applies rules for processing the identified named entities to exclude at least one of common nouns and function words from the named entities;
a feature extraction component for extracting features from the optionally processed source text string relating to the identified named entities;
a prediction component for selecting a translation protocol for translating the source string based on the extracted features, the translation protocol being selected from a set of translation protocols including a first translation protocol in which the named entity is replaced by a placeholder to form a reduced source string, the reduced source string being translated separately from the named entity, and a second translation protocol in which the source text string is translated without replacing the named entity with the placeholder, to produce a target text string in the target language; and
a machine translation component for performing the selected translation protocol; and
a processor for implementing at least one of the components.

15. The system of claim 14, wherein the prediction component inputs the features to a prediction model for predicting whether the translation would be better if the named entity were to be replaced by a placeholder and translated separately.

16. The system of claim 14, comprising the rule applying component.

17. A method for forming a machine translation system comprising:
optionally, providing rules for processing named entities identified in a source text string to exclude at least one of common nouns and function words from the named entities;
with a processor, learning a prediction model for predicting a suitable translation protocol from a set of translation protocols for translating the optionally processed source text string, the learning comprising:
for each of a training set of optionally processed source text strings:
extracting features from the optionally processed source text strings relating to the identified named entities, and
for each of the translation protocols, computing a translation score for a target text string generated by the translation protocol; and
learning the prediction model based on the extracted features and translation scores;
providing a prediction component which applies the model to features extracted from the optionally processed source text string to select one of the translation protocols.

18. The method of claim 17, wherein a first of the translation protocols includes:
forming a reduced source string from the source text string in which the named entity is replaced by a placeholder;
translating the reduced source string by machine translation to generated a translated reduced target string,
processing the named entity separately, and
incorporating the processed named entity into the translated reduced target string to produce a target text string in the target language; and
a second of the translation protocols includes:
translating the source text string by machine translation, without replacing the named entity with the placeholder, to produce a target text string in the target language.

19. The method of claim 17, further generating the rules from a training set of source sentences in which named entities have been recognized.

20. The method of claim 17, further comprising generating a machine translation system for the translating of the reduced source string, the generating comprising:
providing a parallel training corpus of pairs of source and target text strings, at least some of the pair in the parallel corpus including a reduced source string in which at least one named entity is replaced with a placeholder and a reduced target string in which a corresponding named entity is replaced with a placeholder; and
learning the machine translation system using the parallel training corpus.

21. The method of claim 20, wherein for at least a fraction of the named entities there is no placeholder replacement to provide a hybrid machine translation system for translating a source string which contains both a placeholder and an original named entity.

22. A computer program product comprising a non-transitory medium storing instructions, which when executed by a computer, perform the method of claim 17.

23. A system comprising memory storing instructions for performing the method of claim 17 and a processor, in communication with the memory, for executing the instructions.
